(19) United States
(12) Patent Application Publication
(10) Pub. No.: US 2025/0208840 A1
(43) Pub. Date: Jun. 26, 2025

(54) INFORMATION PROCESSING DEVICE, INFORMATION PROCESSING METHOD, AND STORAGE MEDIUM THEREOF

(71) Applicant: DENSO CORPORATION, Kariya-city (JP)

(72) Inventors: Wenhung HUANG, Kariya-city (JP); Hidenori MATSUZAKI, Kariya-city (JP); Shimpei URASAWA, Kariya-city (JP); Yasuhiro HOSHIBA, Nagoya-shi (JP); Mamoru OKUDE, Nagoya-shi (JP)

(21) Appl. No.: 18/991,892

(22) Filed: Dec. 23, 2024

(30) Foreign Application Priority Data
Dec. 26, 2023 (JP) 2023-220021

(51) Int. Cl. G06F 8/41

(52) U.S. Cl. CPC G06F 8/443

(57) ABSTRACT

An information processing device includes a database storing multiple static analysis results of source code and multiple review results of respective static analysis results. The information processing device receives a selection of a copy source and multiple copy destinations from the multiple static analysis results that have been reviewed, and receives a copy processing request for copying the review result of the static analysis result selected as the copy source to the multiple copy destinations. The information processing device acquires, from the database, copy source information of the copy source and copy destination information of each copy destination in response to receiving the copy processing request; determines whether each copy destination is appropriate based on the copy source information and the copy destination information, and outputs the determination result.

### CROSS REFERENCE TO RELATED APPLICATION

The present application claims the benefit of priority from Japanese Patent Application No. 2023-220021 filed on Dec. 26, 2023. The entire disclosure of the above application is incorporated herein by reference.

### TECHNICAL FIELD

The present disclosure relates to an information processing device, an information processing method, and a storage medium thereof.

### BACKGROUND

In software development, static analysis is widely used as a method of ensuring a quality and reliability of software. There are many different types of static analysis tools are provided to the users.

### SUMMARY

An information processing device includes a database storing multiple static analysis results of source code and multiple review results of respective static analysis results. The information processing device receives a selection of a copy source and multiple copy destinations from the multiple static analysis results that have been reviewed, and receives a copy processing request for copying the review result of the static analysis result selected as the copy source to the multiple copy destinations. The information processing device acquires, from the database, copy source information of the copy source and copy destination information of each copy destination in response to receiving the copy processing request; determines whether each copy destination is appropriate based on the copy source information and the copy destination information, and outputs the determination result.

### BRIEF DESCRIPTION OF DRAWINGS

Objects, features and advantages of the present disclosure will become apparent from the following detailed description made with reference to the accompanying drawings. In the drawings:

FIG. 1 is a diagram showing an example of a system configuration of an information processing system;

FIG. 2 is a diagram showing an example of a hardware configuration of a user terminal and an information processing device;

FIG. 3 is a block diagram showing functions of the information processing device;

FIG. 4A is a diagram showing an example of static analysis result data;

FIG. 4B is a diagram showing an example of review result data;

FIG. 5 is a diagram showing an example of a browser display window for a user to manually select a copy source and a copy destination;

FIG. 6 is a diagram showing an example of a browser display window displaying information to be copied to a copy destination and information not to be copied to a copy destination;

FIG. 7A is a diagram showing a warning window forbidding copy;

FIG. 7B is a diagram showing a warning window that displays whether copy is allowed or not in “yes/no” format;

FIG. 8 is a diagram showing an example of browser display window for determining copy;

FIG. 9 is a diagram showing an example of a browser display window displaying copy destination candidates automatically selected by a candidate selection unit based on warning content of copy source in response to the copy source being selected by a user;

FIG. 10 is a flowchart showing a process executed by the information processing device; and

FIG. 11 is a flowchart showing a process in which the information processing device presents candidates of copy destination and prompts a user to perform confirmation.

### DETAILED DESCRIPTION

As described above, although static analysis tools can be easily used for analyzing source code of software program, a huge number of warnings are output from the static analysis tools. Thus, a software engineer needs to check the huge number of warnings one by one and determine whether each warning is related to a defect. Since the check needs to be carried out for the huge number of warnings, the check work requires enormous cost. There is also a concern about check quality since some of the huge number of warnings may be overlooked due to human error.

In a related art, a review support device decreases review time for one warning by displaying past review results as reuse candidates. This review support device properly takes over comments and revision examples assigned to the warning. Thus, correspondence among warnings, comments, and revision examples that are reset for each version update can be automatically constructed, thereby reducing the burden of review work.

However, the review support device of related art still requires recording of determination result for the huge number of warnings one by one. Thus, the recording of determination result for the huge number of warnings still requires time-consuming work.

According to an aspect of the present disclosure, an information processing device includes: a database storing multiple static analysis results of source code and multiple review results of respective static analysis results; an input unit receiving a selection of a copy source and multiple copy destinations from the multiple static analysis results that have been reviewed, and receiving a copy processing request for copying the review result of the static analysis result selected as the copy source to the multiple copy destinations; an acquisition unit acquiring, from the database, copy source information of the copy source and copy destination information of each of the multiple copy destinations in response to receiving the copy processing request; a determination unit determining whether each of the multiple copy destinations is appropriate based on the copy source information and the copy destination information; and an output unit outputting a determination result determined by the determination unit.

According to the above configuration, the determination unit can determine whether each of the multiple copy destinations is appropriate based on the copy source information and the copy destination information. This configuration prevents human error which may occur in copy operation of the review result, and enables review of the static analysis results to be performed with stable and high quality. When determining that each of the multiple copy destinations is appropriate, the review result of copy source can be copied to the multiple copy destinations in bulk at once, thereby increasing review efficiency of the static analysis results.

According to another aspect of the present disclosure, an information processing device includes: a database storing multiple static analysis results of source code and multiple review results of respective static analysis results; an input unit receiving a selection of a copy source from the multiple static analysis results that have been reviewed, and receiving a copy processing request for copying the review result of the static analysis result selected as the copy source; a candidate selection unit automatically selecting, in response to receiving the selection of the copy source, multiple candidates of copy destination based on copy source information of the selected copy source; and a writing unit writing the review result of the copy source to the multiple candidates of copy destination in response to receiving the copy processing request.

In the above configuration, the candidate selection unit automatically selects multiple copy destination candidates based on the copy source information. This allows the user to select, from multiple copy destination candidates that are automatically selected, the copy destination to which the review results should be copied, thereby increasing an efficiency of selecting the copy destination and preventing human error that may occur in copy operation. Thus, the review result of static analysis result can be carried out with stable quality. The review result of the copy source can be copied to multiple copy destinations in bulk at once, thereby increasing review efficiency of the static analysis results.

According to another aspect of the present disclosure, an information processing method is performed by an information processing device. The information processing device includes a database storing multiple static analysis results of source code and multiple review results of respective static analysis results. The information processing method includes: receiving a selection of a copy source and multiple copy destinations from the multiple static analysis results that have been reviewed; receiving a copy processing request for copying the review result of the static analysis result selected as the copy source to the multiple copy destinations; acquiring, from the database, copy source information of the copy source and copy destination information of each of the multiple copy destinations in response to receiving the copy processing request; determining whether each of the multiple copy destinations is appropriate based on the copy source information and the copy destination information; and outputting a determination result indicating whether each of the multiple copy destinations is appropriate.

According to another aspect of the present disclosure, an information processing program, which is stored in a computer-readable non-transitory storage medium is provided. The information processing program is executed by a computer of an information processing device, and the information processing device includes a database storing multiple static analysis results of source code and multiple review results of respective static analysis results. The information processing program causes the computer to perform: receiving a selection of a copy source and multiple copy destinations from the multiple static analysis results that have been reviewed; receiving a copy processing request for copying the review result of the static analysis result selected as the copy source to the multiple copy destinations; acquiring, from the database, copy source information of the copy source and copy destination information of each of the multiple copy destinations in response to receiving the copy processing request; determining whether each of the multiple copy destinations is appropriate based on the copy source information and the copy destination information; and outputting a determination result indicating whether each of the multiple copy destinations is appropriate.

According to the above-described aspects of the present disclosure, it is possible to provide an information processing device, an information processing method, and program thereof, which can increase an efficiency of reviewing static analysis results and ensuring a safe quality for the reviewing of static analysis results.

The following will describe embodiments of the present disclosure with reference to the accompanying drawings. The embodiments described below show an example of the present disclosure, and the present disclosure is not limited to the specific configuration described below. In an implementation of the present disclosure, a specific configuration according an embodiment may be adopted as appropriate.

### 1. System Configuration

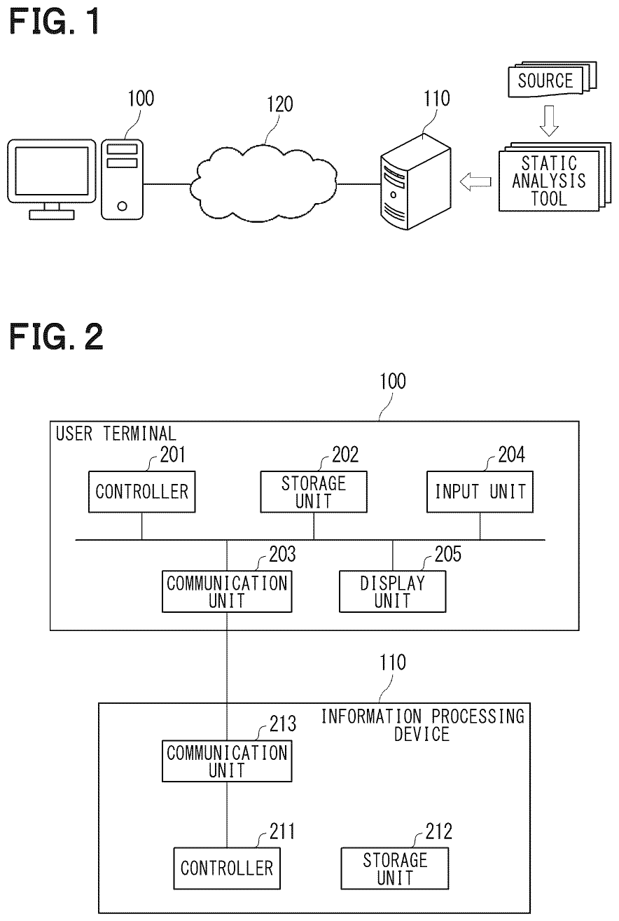

FIG. 1 is a diagram showing an example of a system configuration of an information processing system according to the present embodiment. As shown in FIG. 1, the information processing system includes a user terminal 100, an information processing device 110 which is provided by a server device, and a network 120. The user terminal 100 and the information processing device 110 are connected with one another via the network 120 so as to perform communicate with one another. A user such as a software developer accesses the information processing device 110 via a web browser on the user terminal 100 to manage data of static analysis results. The information processing device 110 receives, as an input, analysis result of software source code, which is analyzed by a static analysis tool, and manages the received data of static analysis result. The information processing device 110 receives, as inputs, multiple static analysis results analyzed by multiple static analysis tools.

### 2. Hardware Configuration

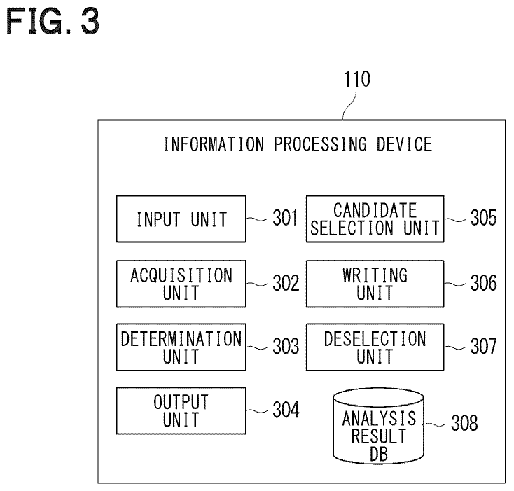

FIG. 2 is a diagram showing an example of hardware configuration of the user terminal 100 and the information processing device 110 according to the present embodiment. The user terminal 100 is a terminal carried by a user, such as a notebook computer. The type of user terminal 100 may be a desktop computer, a tablet terminal, a smartphone, or the like. The user terminal 100 includes a controller 201, a storage unit 202, a communication unit 203, an input unit 204, and a display unit 205, and these components are electrically connected with one another via a communication bus of the information processing device 100.

The controller 201 processes and controls an overall operation of the user terminal 100. For example, the controller 201 is provided by a central processing unit (CPU). The controller 201 reads out a predetermined program stored in the storage unit 202, and executes the program to implement various functions related to the user terminal 100. Thus, information processing by the software stored in the storage unit 202 is executed by the controller 201, which corresponds to a hardware circuit, thereby implementing each functional unit included in the controller 201. The controller 201 is not limited to a single controller. For example, multiple controllers 201 may be provided for respective functions. As another example, a single controller configuration may be combined with multiple controller configuration.

The storage unit 202 may be implemented by a non-transitory storage medium, such as a solid state drive (SSD) that stores various programs related to the user terminal 100. The various programs related to the user terminal 100 are executed by the controller 201. As another example, the storage unit 202 may be implemented by a memory, such as a random access memory (RAM) that temporarily stores required information (argument of a function, array, etc.) related to the calculation of program. The storage unit 202 stores various programs, which are related to the user terminal 100 and are executed by the controller 201, variables, and data to be used when the controller 201 executes a process based on the corresponding program. The program causes a computer to function as a controller of the user terminal 100.

The communication unit 203 may be provided by a wired communication method, such as universal serial bus (USB), IEEE 1394, Thunderbolt (registered trademark), wired LAN network communication. The communication unit 203 may also be provided by a wireless LAN network communication, mobile communication such as 3G, LTE, 5G, Bluetooth (registered trademark) communication, as necessary. The communication unit 203 may adopt a combination of the wired communication method and wireless communication method. The user terminal 100 may communicate various information transmitted from outside via the communication unit 203 and the network 120.

The input unit 204 may be included in a housing of the user terminal 100 or may be attached to the user terminal 100 as an external input unit. For example, the input unit 204 may be integrated with the output unit 205, and implemented as a touch panel. When the input unit is provided as the touch panel, the user can input a tap operation, a swipe operation, or the like on the touch panel. Instead of the touch panel, a switch button, a mouse, a QWERTY layout keyboard device, or the like may be used as the input unit. The input unit 204 receives an operation input made by the user. The input from the user is transferred as a command signal to the controller 201 via the communication bus, and the controller 201 can execute predetermined control and calculation corresponding to the command signal, as necessary.

The display unit 205 may be included in the housing of the user terminal 100 or may be attached to the user terminal 100 as an external display unit. The display unit 205 displays a graphical user interface (GUI) that enables a user operation in a display window. The display unit 205 may be implemented by selectively using a display device, such as a cathode-ray tube (CRT) display, a liquid crystal display, an organic electroluminescent (EL) display, a plasma display, according to the type of user terminal 100.

The information processing device 110 includes at least a controller 211, a storage unit 212, a communication unit 213, and a communication bus electrically connecting the components via in the information processing device 110. The controller 211, the storage unit 212, and the communication unit 213 of the information processing device 110 are similar to the controller 201, the storage unit 202, and the communication unit 203 of the user terminal 100, and detailed description will be omitted.

### 3. Functional Configuration

Various functions of the information processing device 110 are implemented when the controller 211, which corresponds to a hardware circuit, performs the information processing by executing software programs stored in the storage unit 212.

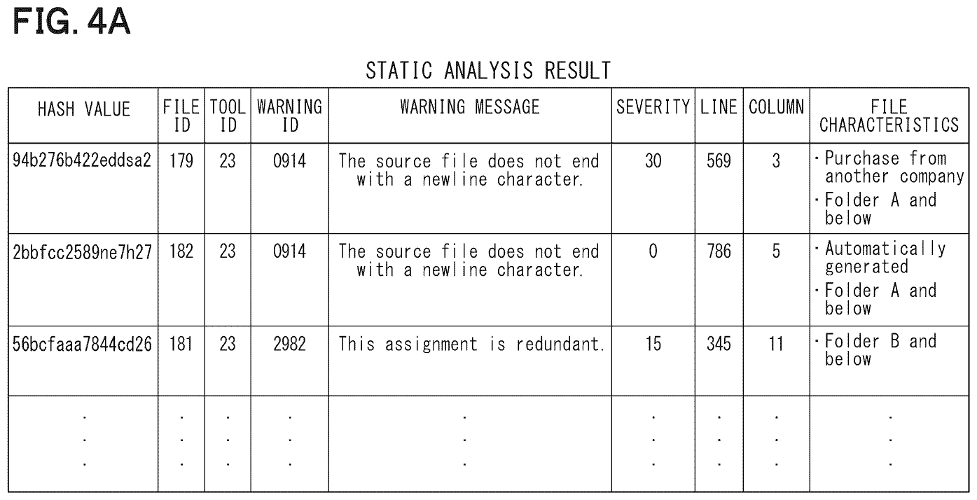

FIG. 3 is a block diagram showing functions of the information processing device 110. Specifically, the information processing device 110 includes an input unit 301, an acquisition unit 302, a determination unit 303, an output unit 304, a candidate selection unit 305, a writing unit 306, and a deselection unit 307. The information processing device 110 further includes an analysis result database 308.

The analysis result database 308 stores static analysis results, which are the results of analyzing the source code of the software using static analysis tools, and further stores review results of the static analysis results. The analysis result database 308 may store the source code. The analysis result database 308 stores the static analysis results for multiple software programs constituting a software product project.

The static analysis results include data related to warnings, which warn about the source code descriptions that may result in bugs, and include data indicating location of syntax error in the source code and a type of the syntax error. The review result indicates a result after a user reviews a warning, and includes information such as the user who performed the review, review comment, and a review status indicating whether the review has been finished.

There are various types of static analysis tools. The analysis result database 308 stores the static analysis results analyzed by different static analysis tools. The static analysis results vary depending on the type of static analysis tool. For example, a description that is detected as a warning by one static analysis tool may not be detected as a warning by another static analysis tool. This is due to the specifications of static analysis tools are different from one another, and different static analysis tools are good at different analyzing fields. The analysis result database 308 stores the static analysis results obtained from different static analysis tools, thereby enabling a highly accurate review.

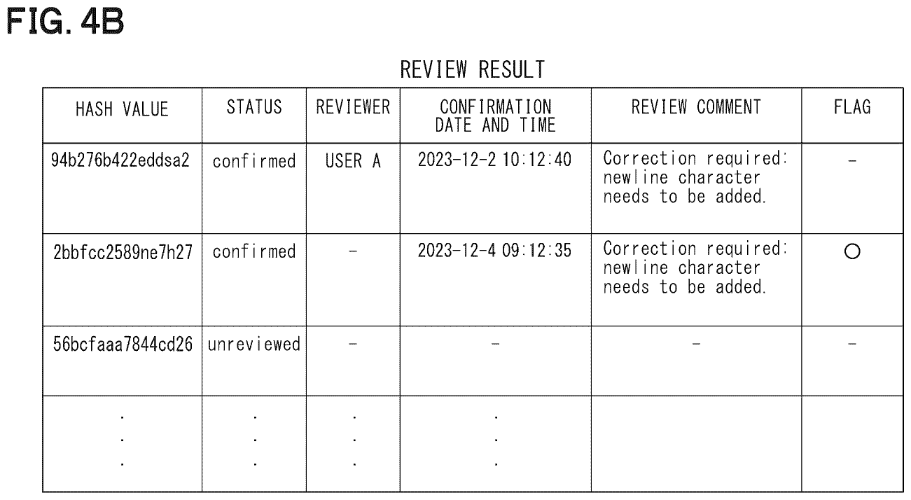

FIG. 4A shows an example of data of static analysis results stored in the analysis result database 308. Each static analysis result include data about a file ID, a tool ID, a warning ID, a warning message, a severity, a line, a column, and file characteristics, in association with a hash value.

The hash value is identification information that identifies the warning, and is calculated based on the warning related data and code included in the warning related line. By using the hash value as identification information of warning, the same warning can be easily identified across different versions of source files. By using the hash value, a warning that has already been reviewed can be avoided from being reviewed again, thereby significantly reducing the time required to review the source code.

The file ID in static analysis result indicates a file ID of the source file that is a target of the static analysis. The tool ID in static analysis result indicates an ID of the static analysis tool that detected the warning. The warning message in static analysis result informs the user of the warning content. The warning ID in static analysis result identifies the warning and is associated with the warning message. In the present disclosure, the warning ID is also referred to as warning content.

The severity in static analysis result indicates a seriousness of the warning. The severity in static analysis result is expressed within a number range of 0 and 30, and the higher the number, the more severe the warning. The line and column in static analysis result identify the location of code associated with the warning. The line indicates a line number where the code associated with the warning starts. The column indicates a column number of the code associated with the warning within in the file. The file characteristics in static analysis result indicate the characteristics of the target file. For example, the file characteristics indicates automatically generated source code, source code purchased from another company, or source code under a certain folder. In FIG. 4A, “folder A and below” indicates that the files are stored in the folder A or a folder below the folder A. Note that the above-described configuration is an example of static analysis result. The static analysis result may include data other than the example data shown in FIG. 4A.

FIG. 4B shows an example of review result data stored in the analysis result database. The review result data is linked to a hash value, which is associated with the static analysis result. The review result data includes data on the status, reviewer, confirmation date and time, review comment, and flag.

The hash value in the review result data corresponds to the hash value in the static analysis result data, and identifies the corresponding warning in the static analysis result data. The status in the review result data indicates a review status of the warning identified by the hash value. For example, “confirmed” indicates that the warning has been confirmed, and “unreviewed” indicates that the warning has not yet been reviewed. The reviewer in the review result data indicates a name of user who reviewed the warning and changed a status of the warning. The confirmation date and time in the review result data indicates date and time when the content of warning is confirmed (that is, reviewed). The review comment in the review result data indicates comment made by the reviewer who reviewed the warning. The flag in the review result data indicates whether the review result is a copy or not. For example, a circle in the flag indicates that the review result is a copy. Note that the above-described configuration is an example of review result data. The review result data may include data other than those shown in FIG. 4B.

The input unit 301 receives the selection of a copy source and a copy destination. One of the reviewed static analysis results is manually selected as a copy source by a user by performing a browser operation. One or more copy destinations are manually selected by the user by performing a browser operation. Multiple copy destinations may be selected in bulk based on an element common to the multiple copy destinations. As an example, the copy destinations may be sorted by warning content, and then multiple copy destinations may be selected in bulk based on the warning content.

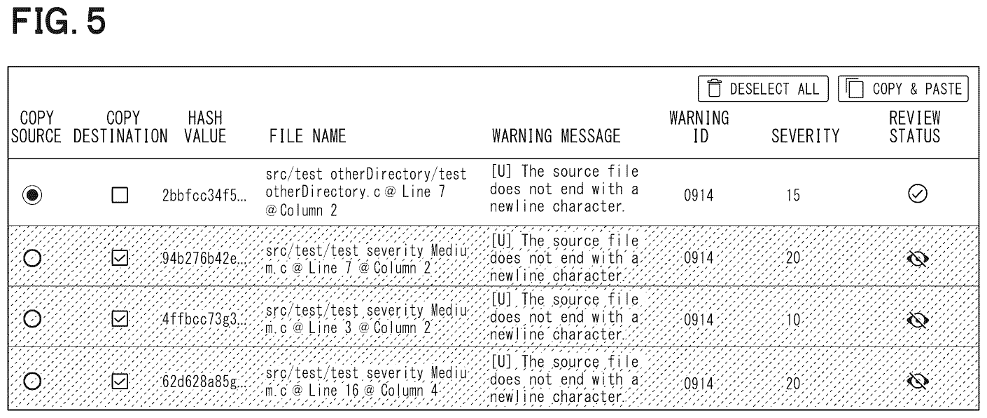

FIG. 5 is a diagram showing an example of a browser display screen for the user to manually select a copy source and a copy destination. As shown in FIG. 5, the user can select the copy source by checking, that is, clicking a radio button of the copy source. The user can select the copy destination by checking, that is, clicking a check box of the copy destination.

The input unit 301 receives a copy processing request for copying the review result of the corresponding static analysis result from the copy source to the copy destination. When the user clicks on “copy & past” (refer to FIG. 5) on the browser, the input unit 301 receives the copy processing request. The input unit 301 receives various commands or requests when the user performs operations on the browser. For example, the input unit 301 receives a command to copy the review result from the copy source to the copy destination, or receives a deselection request to deselect the copy destinations that are in selected states in bulk.

In response to receiving the copy processing request, the acquisition unit 302 acquires, from the analysis result database 308, information of the copy source (hereinafter referred to as copy source information) and information of the copy destination (hereinafter referred to as copy destination information). The copy source information is the static analysis result that has been reviewed, and therefore includes the static analysis result and the review result of the corresponding static analysis result. The copy destination information may include static analysis result that has not yet been reviewed, and may not include the review result of the static analysis result.

The determination unit 303 determines whether the copy destination is appropriate based on the copy source information and the copy destination information. Specifically, the determination unit 303 determines whether the copy destination is appropriate based on the warning content of the copy source information and the warning content of the copy destination information. When the warning content of copy source information matches with or equals to the warning content of copy destination information, the determination unit 303 determines that the copy destination is appropriate. When the warning content of copy source information does not match with or does not equal to the warning content of copy destination information, the determination unit 303 determines that the copy destination is inappropriate. The determination unit 303 determines whether the copy destination is appropriate or not based on the review status of the copy destination information. When the review status is “unreviewed”, the determination unit 303 determines that the copy destination is appropriate. The review comment of the copy destination may also be taken into consideration to determine whether the copy destination is appropriate.

In the present embodiment, the determination unit 303 determines that the copy destination is appropriate when the warning content of copy source is same as the warning content of copy destination and the copy destination is in an unreviewed state. The determination performed by the determination unit 303 as to whether the copy destination is appropriate is not limited to this configuration. Whether the copy destination is considered to be appropriate or not depends on the user's process and way of thinking. Thus, a criterion based on which the copy destination is determined to be appropriate or not may be customized. For example, whether the copy destination is appropriate or not may be determined depending on the characteristics of the target file. When the characteristic of file is at least one of automatically generated source code, source code purchased from another company, or source code stored in a certain folder or a folder below the certain folder, the files may be set as “not eligible” as the copy destination in bulk.

The output unit 304 outputs a determination result determined by the determination unit 303. The output unit 304 displays the determination result obtained from the determination unit 303 on the display unit 205 of the user terminal 100 via the browser. The output unit 304 displays various information on the display unit 205 of the user terminal 100 via the browser. For example, when the input unit 301 receives a copy processing request, the output unit 304 outputs copy target information to be copied to the copy destination and non-copy information not to be copied to the copy destination, among the review results of the copy source information. Among the review result of copy source information, for example, the copy target information to be copied to the copy destination includes the review status and review comment. The non-copy information that is not copied to the copy destination includes, for example, the hash value, the reviewer who confirmed the warning, and the confirmation date and time.

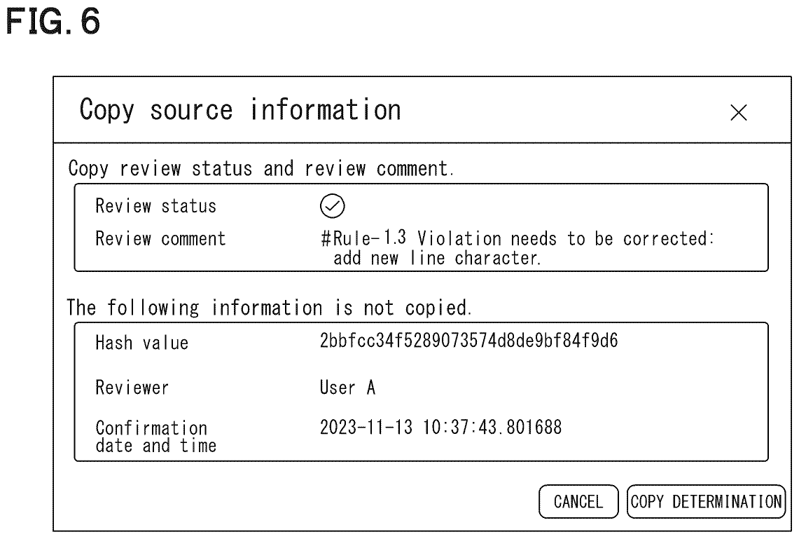

FIG. 6 is a diagram showing an example of a browser display window that displays information to be copied to the copy destination and information not to be copied to the copy destination. As shown in FIG. 6, by displaying the copy target information and non-copy information using the output unit 304, the user can easily know which information is planned to be copied to the copy destination and which information is not planned to be copied to the copy destination.

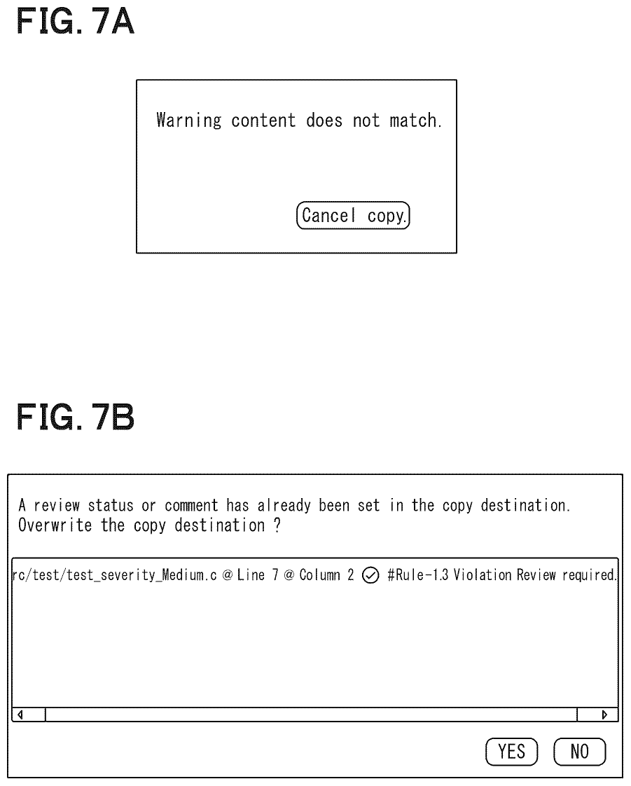

When the determination unit 303 determines that the copy destination is not appropriate, the output unit 304 outputs a warning window as a determination result. The warning window includes at least one of the review status and review comment among the review result of the copy destination information. FIG. 7A and FIG. 7B are diagrams showing examples of browser display windows each displays a warning window. As shown in FIG. 7A, when the warning content of copy source does not match with or equal to the warning content of copy destination, a warning window is displayed to notify the user that the copy is not permitted. The warning window displays “warning content does not match”, and the user can only select cancellation of the copy. This configuration can prevent the user from accidentally performing the copy operation to the copy destination, thereby preventing human error. As shown in FIG. 7B, when the warning content of copy source matches with or equal to the warning content of copy destination but the status of copy destination information is not “unreviewed”, a review status indicating that the copy destination information has been reviewed and corresponding review comment are displayed in the warning window, together with a message “A review status or review comment has already been set in the copy destination. Overwrite the copy destination?” This allows the user to avoid performing copy operation to the copy destination by mistake, and thus human error can be prevented. In the case of FIG. 7B, even when a warning window is displayed, there is a possibility that the copy may be performed. Thus, the warning window includes an area that displays whether to perform the copy operation in “yes/no” format, similar to the determination window, which will be described below.

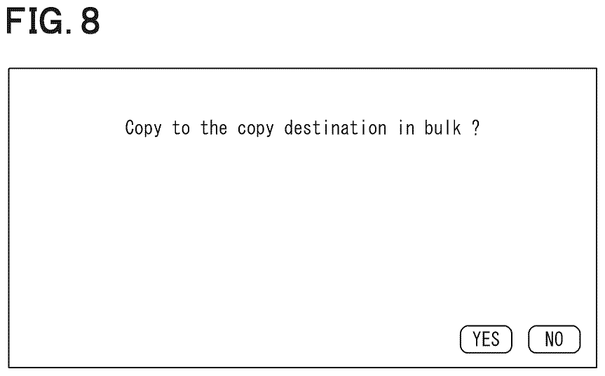

When the determination unit 303 determines that the copy destination is appropriate, the output unit 304 outputs a determination window as the determination result. The determination window prompts the user to determine whether or not to copy the review result, which corresponds to the copy source, to the copy destination. For example, the determination window displays whether or not to copy the review result in a “yes/no” format. FIG. 8 is a diagram showing an example of browser display window that displays the determination window. As shown in FIG. 8, the output unit 304 displays “Copy to the copy destination in bulk?” and displays an area for allowing the user to select “yes” or “no.” When the determination unit 303 determines that the copy destination is appropriate, the copy may be performed without outputting the determination window from the output unit 304. As will be described later, the output unit 304 displays copy destination candidates automatically selected by the candidate selection unit 305 on the browser display window.

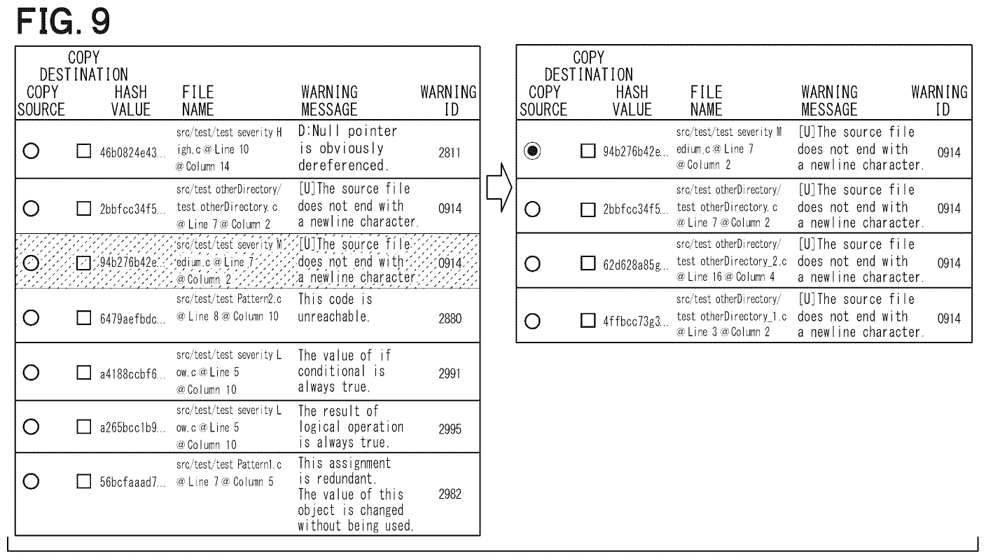

The candidate selection unit 305 automatically selects candidates of the copy destination based on the copy source information of the copy source. Specifically, in response to the input unit 301 receiving a selection of copy source by the user, the candidate selection unit 305 selects one or more copy destination candidates based on the warning content of the selected copy source. FIG. 9 shows an example of browser display window which displays multiple copy destination candidates in response to a user selecting a copy source. The candidate selection unit 305 automatically selects the copy destination candidates based on the warning content of the selected copy source. The user selects a copy destination from the multiple copy destination candidates by checking, that is, clicking a corresponding check box.

As shown in left table of FIG. 9, when the user selects the hash value of “94b276b42e . . . ” as copy source information, the candidate selection unit 305 automatically selects copy destination candidates based on the warning content of the selected copy source. Then, as shown in right table of FIG. 9, copy destination information having equal warning contents are displayed as copy destination candidates below the copy source information.

When the user selects the copy source, the copy source must have been reviewed. The data with review status of “unreviewed” may be controlled to be not selectable by the GUI. For example, as shown in left table of FIG. 9, the radio button corresponding to data that cannot be selected may be deactivated.

The candidate selection unit 305 may select the copy destination candidates based on the copy source information of the selected copy source using a machine learning model, which outputs copy destination candidates based on input of copy source information. This kind of machine learning model is generated by performing learning for past performance data indicating copy operations of the review results from the copy source to the copy destination. The copy operations are performed by the users.

The machine learning model may receive, as input, copy source information of the copy source, and output copy destination information of the copy destination. The machine learning model may receive, as inputs, copy source information of the copy source and copy destination information of the copy destination, and output a probability indicating an appropriateness as the copy destination. In the case of former model that receives copy source information as input, the candidate selection unit 305 inputs the copy source information of the copy source to the model, obtains an attribute required for the warning of the copy destination, and selects a copy destination that matches the attribute. In the latter model that receives copy source information and copy destination information as inputs, the candidate selection unit 305 sequentially inputs the copy source information of the copy source and the copy destination information of the copy destination, and selects the copy destination that has the highest accuracy rate.

The writing unit 306 writes data into the analysis result database 308. When the input unit 301 receives a command to copy the review results of the copy source from the copy source to the copy destination (i.e., when the user selects “yes” in FIG. 8), the writing unit 306 writes review results in the copy source to the copy destination in bulk. When writing the copy source information to the copy destination in bulk, the writing unit 306 writes, in the review result of copy destination, the person who decided to perform the copying or a flag indicating that the review result written in the copy destination is copied information.

When the input unit 301 receives a deselection request to deselect the copy destination in selected state (i.e., when the user clicks “deselect all” in FIG. 5), the deselection unit 307 deselects, in bulk, the copy sources in selected states and the copy destinations in selected states. This eliminates the need for the user to cancel the selection of copy sources and copy destinations one by one before performing the next operation, thereby improving operability.

### 4. Information Processing Method

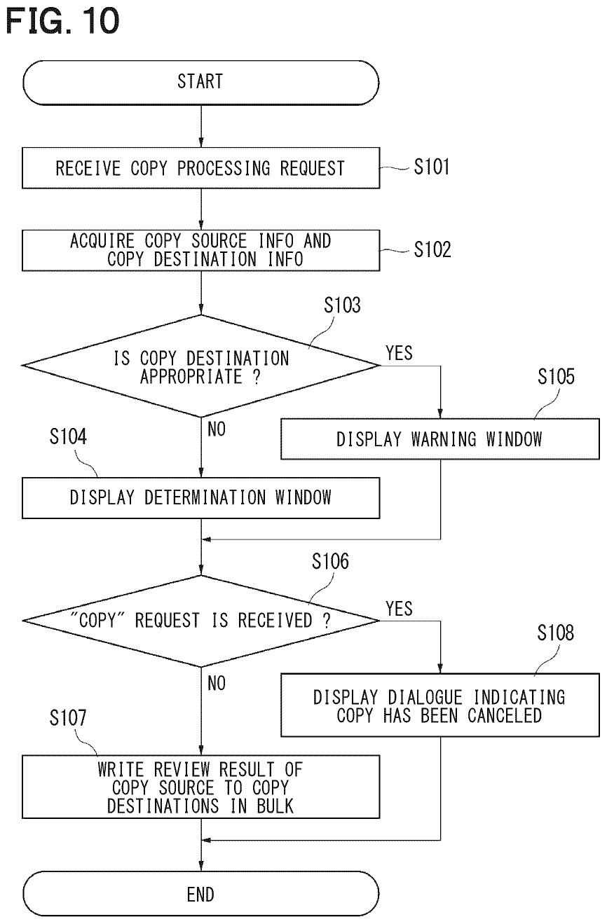

The following will describe an information processing method performed by the information processing device 110. FIG. 10 is a flowchart showing a process executed by the information processing device 110.

In S101, the input unit 301 receives, from the user terminal 100, a selection of copy source from the reviewed static analysis results, receives a selection of copy destination, and receives a copy processing request to copy the review results of the static analysis results of the copy source from the copy source to the copy destination. The selection of copy source is performed by checking a radio button, and the selection of the copy destination is performed by checking a check box (see FIG. 5). The input unit receives the copy processing request in response to the user clicking the “copy & paste” button (see FIG. 5).

In S102, in response to the input unit 301 receiving the copy processing request, the acquisition unit 302 acquires copy source information of the copy source and copy destination information of the copy destination from the analysis result database 308. At this time, as shown in FIG. 6, the output unit 304 may display, on the display unit 205 of the user terminal 100, information to be copied to the copy destination and information not to be copied to the copy destination via a browser.

In S103, the determination unit 303 determines whether the copy destination is appropriate based on the copy source information and the copy destination information. This determination may be performed in response to the user clicking a “copy determination” button in a window, which displays information to be copied to the copy destination and information not to be copied to the copy destination. The window may be displayed by the output unit 304 when the input unit 301 accepts the copy processing request from the user (see FIG. 6). The determination may also be performed automatically when the acquisition unit 302 acquires the copy source information and the copy destination information. As described above, the determination as to whether the copy destination is appropriate is made based on the warning content of the copy source and the warning content of the copy destination. The determination unit further determines whether the copy destination is appropriate based on the review status of copy destination. The determination unit further determines whether the copy destination is appropriate with consideration of review comment of the copy destination. When the copy destination is determined to be appropriate, the flow proceeds to S104. When the copy destination is determined to be not appropriate, the flow proceeds to S105.

In S104, the output unit 304 displays a determination window (see FIG. 8) as a result of appropriateness determination on the display window of browser. It should be noted that when the copy destination is determined to be appropriate and copy operation is performed as is, S104 may be omitted.

In S105, the output unit 304 displays a warning window as a result of appropriateness determination on the display window of browser. For example, as shown in FIG. 7B, in the warning window, a review status indicating that the copy destination information has been reviewed and a review comment thereof may be displayed.

In S106, the input unit 301 confirms whether a copy determination is input by the user. The copy determination is confirmed when “yes” is selected on the determination window, or when “yes” is selected on the warning window. When the input unit 301 receives a command to “copy”, the flow proceeds to S107. When the input unit 301 receives a command to “not copy” (that is, when “no” is selected on the determination window or warning window), the flow proceeds to S108.

In S107, the writing unit 306 writes the review results of the copy source in bulk to the copy destination. The flow then ends.

In S108, the output unit 304 displays a dialogue message indicating that the copy has been canceled on the display window of browser. The flow then ends.

After S107 and S108, the selected copy source and copy destination remain in checked states on the display window of browser. The user then clicks on “deselect all” shown in FIG. 5. When the “deselect all” is clicked by the user, the input unit 301 receives the deselection request to deselect the copy sources in selected states and the copy destination in selected states, and the deselection unit 307 deselects, in bulk, the copy sources in selected states and the copy destinations in selected states. After S107 and S108, the copy sources and copy destinations may be unchecked on the display window of browser.

### OTHER EMBODIMENTS

Although one embodiment of the present disclosure has been described above, the present disclosure is not construed as being limited to the above-described embodiments, and can be applied to various embodiments and combinations within a scope that does not depart from the spirit of present disclosure.

### (Modifications)

In the present embodiment, the candidate selection unit 305 selects candidate copy destinations, and after the user specifies a copy destination from the candidate copy destinations, the determination unit 303 determines whether the copy destination is appropriate. As another example, when the candidate selection unit 305 selects the copy destination candidate, the candidate selection unit 305 may determine whether the copy destination candidate is appropriate. In this case, the candidate selection unit 305 may select the copy destination candidate based on the copy source information of the copy source. Similar to the process performed by the determination unit 303, the copy destination candidate may be selected based on the warning content of copy source and the warning content of copy destination candidate. Similar to the process performed by the determination unit 303, the candidate selection unit 305 may select the copy destination candidate based on the warning content of copy source, the warning content of copy destination candidate, and the review status of copy destination candidate. The candidate selection unit 305 may use the above-described machine learning model to select the copy destination candidate based on the copy source information of the selected copy source. The candidate selection unit 305 may select the copy destination instead of the copy destination candidate.

In the above-described embodiment, a user selects a copy source and multiple copy destinations first, and then each of the multiple copy destinations is determined as to whether it is appropriate as the copy destination. As another example, the information processing device 110 may select copy destination candidates using the candidate selection unit 305 first, and present the selected copy destination candidates to the user. Then, the user may select a copy destination from the presented copy destination candidates. That is, the information processing device 110 may have a function of suggesting a copy destination to the user.

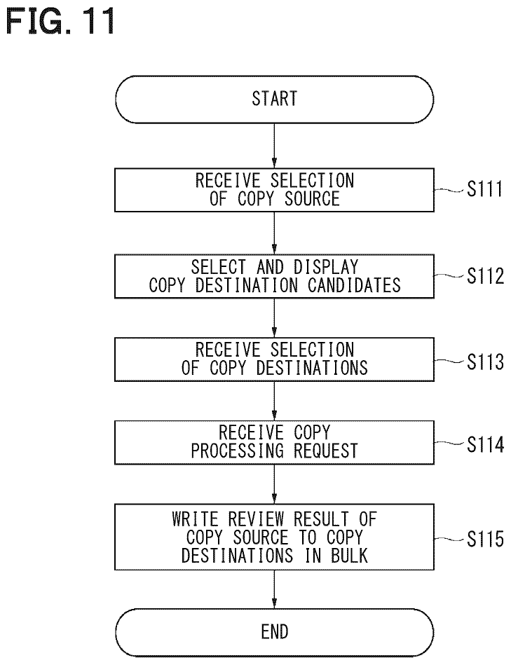

FIG. 11 is a flowchart showing the flow of operation performed by the information processing device 110 to present copy destination candidates to the user for confirmation.

In S111, the input unit 301 receives a selection of copy source from the user terminal 100.

In S112, the candidate selection unit 305 selects copy destination candidates based on the copy source information of the copy source. The candidate selection unit 305 determines the copy destination candidates based on the copy source information of the selected copy source, for example, by using a machine learning model generated in advance. This kind of machine learning model is generated by learning past performance data indicating copy operations of review results from the copy source to the copy destination. The copy operations are performed by the user.

Then, the information processing device 110 transmits the copy destination candidate data to the user terminal 100. The user terminal 100 displays the copy destination candidate data on the user terminal.

In S113, the input unit 301 receives selection of copy destination from the user terminal 100. That is, S113 is a step in which the user selects, from the warnings displayed as copy destination candidates, a copy destination considered to be safe.

In S114, the input unit 301 receives the copy processing request.

In S115, the writing unit 306 writes the review results of the copy source to the copy destination in bulk. The flow then ends.

In this configuration, the information processing device 110 presents the copy destination corresponding to warning of the copy source, thus the display information which the user should confirm can be reduced, and thereby facilitating the task of searching for the copy destination.

When the user manually selects a copy destination and the selected copy destination is not appropriate, the output unit 304 may immediately display a warning window indicating that the selected copy destination is not appropriate. In this case, the determination as to whether the copy destination is appropriate or not may be made based on the warning content of copy source and the warning content of copy destination, similar to the process executed by the determination unit 303. Alternatively, the determination may be made based on the warning content of copy source, the warning content of copy destination, and the review status of copy destination. The determination may also be made using the machine learning model as described above.

The controller and the method thereof described in the present disclosure may be implemented by a special purpose computer, which includes a processor programmed to execute one or more functions performed by computer programs. Alternatively, the controller and the method thereof according to the present disclosure may be implemented by a dedicated hardware logic circuit. Alternatively, the controller and the method thereof according to the present disclosure may be implemented by one or more dedicated computers implemented by a combination of a processor that executes a computer program and one or more hardware logic circuits. The computer program may also be stored in a computer-readable non-transitory tangible storage medium as instructions to be executed by a computer.

Further, the flow of process in the above embodiments is described as an example. Unnecessary steps may be deleted from the flow, new steps may be properly added to the flow, or the execution order may be properly changed without departing from the scope of the present disclosure.

What is claimed is:

1. An information processing device comprising:
a database storing multiple static analysis results of source code and multiple review results of respective static analysis results;
an input unit receiving a selection of a copy source and multiple copy destinations from the multiple static analysis results that have been reviewed, and receiving a copy processing request for copying the review result of the static analysis result selected as the copy source to the multiple copy destinations;
an acquisition unit acquiring, from the database, copy source information of the copy source and copy destination information of each of the multiple copy destinations in response to receiving the copy processing request;
a determination unit determining whether each of the multiple copy destinations is appropriate based on the copy source information and the copy destination information; and
an output unit outputting a determination result determined by the determination unit.

2. The information processing device according to claim 1, further comprising
a candidate selection unit automatically selecting multiple copy destination candidates as candidates of the multiple copy destinations.

3. The information processing device according to claim 2, wherein
the candidate selection unit selects the multiple copy destination candidates based on a warning content of the static analysis result selected as the copy source.

4. The information processing device according to claim 2, wherein
the candidate selection unit selects the multiple copy destination candidates using a machine learning model based on the copy source information of the copy source, and
the machine learning model outputs the multiple copy destination candidates based on input of the copy source information of the copy source.

5. The information processing device according to claim 1, wherein,
among the review result of the copy source information, the output unit outputs information to be copied to the multiple copy destinations and information not to be copied to the multiple copy destinations.

6. The information processing device according to claim 5, wherein
the information to be copied to the multiple copy destinations includes a review status and a review comment among the review result of the copy source information.

7. The information processing device according to claim 1, wherein
the determination unit determines whether each of the multiple copy destinations is appropriate based on a warning content of the source code included in the copy source information and a warning content of the source code included in the copy destination information.

8. The information processing device according to claim 7, wherein
the determination unit determines whether each of the multiple copy destinations is appropriate using a review status of warning as the copy destination information.

9. The information processing device according to claim 1, wherein,
when the determination unit determines that one of the multiple copy destinations is inappropriate, the output unit outputs a warning window as the determination result.

10. The information processing device according to claim 9, wherein
the warning window includes at least one of a review status or a review comment among the review result of the copy destination information.

11. The information processing device according to claim 1, wherein
the database stores the multiple static analysis results in units of software programs, which constitute a product project.

12. The information processing device according to claim 1, wherein
each of the multiple static analysis results and the review result of each of the multiple static analysis results are linked to a hash value, which is based on the corresponding static analysis result.

13. The information processing device according to claim 1, further comprising
a writing unit writing data to the database,
wherein,
when the determination unit determines that the multiple copy destinations are appropriate, the output unit outputs a determination window as the determination result,
the determination window guides a user to determine whether to copy the review result of the copy source from the copy source to the multiple copy destinations, and
when the input unit receives a command to copy the review result of the copy source from the copy source to the multiple copy destinations, the writing unit writes the review result of the copy source to the multiple copy destinations.

14. The information processing device according to claim 13, wherein,
when the writing unit writes the review result of the copy source, the writing unit writes at least one of (i) a flag indicating that the review result of each of the multiple copy destinations is copied information or (ii) a reviewer who made a copy determination, in the review result of each of the multiple copy destinations.

15. The information processing device according to claim 1, further comprising
a deselection unit deselecting, in response to receiving a deselection request to deselect the multiple copy destinations that are in selected states, the copy source, which is in a selected state, and the multiple copy destinations, which are in the selected states.

16. An information processing device comprising:
a database storing multiple static analysis results of source code and multiple review results of respective static analysis results;
an input unit receiving a selection of a copy source from the multiple static analysis results that have been reviewed, and receiving a copy processing request for copying the review result of the static analysis result selected as the copy source;
a candidate selection unit automatically selecting, in response to receiving the selection of the copy source, multiple candidates of copy destination based on copy source information of the selected copy source; and
a writing unit writing the review result of the copy source to the multiple candidates of copy destination in response to receiving the copy processing request.

17. An information processing method performed by an information processing device that includes a database storing multiple static analysis results of source code and multiple review results of respective static analysis results, the information processing method comprising:
receiving a selection of a copy source and multiple copy destinations from the multiple static analysis results that have been reviewed;
receiving a copy processing request for copying the review result of the static analysis result selected as the copy source to the multiple copy destinations;
acquiring, from the database, copy source information of the copy source and copy destination information of each of the multiple copy destinations in response to receiving the copy processing request;
determining whether each of the multiple copy destinations is appropriate based on the copy source information and the copy destination information; and
outputting a determination result indicating whether each of the multiple copy destinations is appropriate.

18. A computer-readable non-transitory storage medium storing an information processing program to be executed by an information processing device, the information processing device including a database storing multiple static analysis results of source code and multiple review results of respective static analysis results, the information processing program comprising instructions to be executed by a computer of the information processing device and the instructions comprising:
receiving a selection of a copy source and multiple copy destinations from the multiple static analysis results that have been reviewed;
receiving a copy processing request for copying the review result of the static analysis result selected as the copy source to the multiple copy destinations;
acquiring, from the database, copy source information of the copy source and copy destination information of each of the multiple copy destinations in response to receiving the copy processing request;
determining whether each of the multiple copy destinations is appropriate based on the copy source information and the copy destination information; and
outputting a determination result indicating whether each of the multiple copy destinations is appropriate.
